(19) United States
(12) Patent Application Publication
(10) Pub. No.: US 2024/0243602 A1
(43) Pub. Date: Jul. 18, 2024

(54) Charging Circuit and Charger

(71) Applicant: Anker Innovations Technology Co., Ltd., Changsha (CN)

(72) Inventor: Chao Ma, Changsha (CN)

(21) Appl. No.: 18/414,663

(22) Filed: Jan. 17, 2024

(30) Foreign Application Priority Data
Jan. 18, 2023 (CN) 202320136125.1

(51) Int. Cl. H02J 7/00

(52) U.S. Cl. CPC H02J 7/007182; H02J 7/0013

(57) ABSTRACT

A charging circuit comprises a first controller, a main circuit module, and an output port module. The first controller has a first control input and a first control output.

The first control input is configured to connect to an external power source. The main circuit module has a voltage input and a voltage output. The voltage input is connected to the first control output. The main circuit module comprises a transformer connected to an external load, providing a charging voltage to the external load. The first controller may control the first control output to selectively output a supply input voltage based on the charging voltage. Additionally or alternatively, a voltage output of the main circuit module is capable of selectively outputting another supply output voltage based on the charging voltage. Both can improve the energy conversion efficiency of the charging circuit.

### CROSS-REFERENCE TO RELATED APPLICATION

The present application claims priority to CN application Ser. No. 20/232,0136125.1, filed on Jan. 18, 2023. The above application is incorporated by reference in its entirety.

### Field

The present application relates to the technical field of charging, in particular to a charging circuit and a charger.

### Background

In the relevant technical field, charging circuits typically supply power to external devices with a certain supply voltage and charging voltage. Due to the large potential difference between the supply voltage and the charging voltage, the energy conversion efficiency of the charging circuit is relatively low.

Summary

The application provides a charging circuit and a charger, aiming to reduce the potential difference between the supply voltage and the charging voltage, thereby improving the energy conversion efficiency of the charging circuit.

The application describes a charging circuit that comprises a first controller, a main circuit module, and an output port module. The first controller has a first control input and a first control output. The first control input may be connected to an external power source. The main circuit module has a voltage input and a voltage output. The voltage input may be connected to the first control output. The main circuit module comprises a transformer. A primary winding of the transformer may be connected to the voltage input, and a secondary winding may be connected to the voltage output. The output port module is connected to the voltage output and is configured to connect to an external load and provide a charging voltage to the external load. The first controller is configured to configure the external power source into multiple supply input voltages. All of the multiple supply input voltages may be of different magnitudes, and each supply input voltage forms multiple supply output voltages at the voltage output after being stepped down by the transformer. The output port module may use one of the supply output voltages to form the charging voltage to power the external load. The first control output can selectively output a supply input voltage based on the charging voltage, and/or, the voltage output can selectively output another supply output voltage based on the charging voltage.

Based on the above example, the first controller can selectively output a power supply input voltage according to the charging voltage output by the output port module, in order to reduce the difference between the input voltage of the first controller and the power supply input voltage, thereby improving the energy conversion efficiency of the charging circuit. It can be understood that the voltage output of the main circuit module can also selectively output another power supply output voltage according to the charging voltage, in order to reduce the difference between the power supply output voltage and the charging voltage, which can also improve the energy conversion efficiency of the charging circuit. The first control output can selectively output a power supply input voltage according to the charging voltage, and at the same time, the voltage output can selectively output another power supply output voltage according to the charging voltage, which can also improve the energy conversion efficiency of the charging circuit.

This application example also provides a charger, which comprises a housing, a circuit board, and the aforementioned charging circuit. The circuit board is set within the housing, and the charging circuit may be set on the circuit board.

Based on an implementation of this application, a charging circuit is provided, which comprises a first controller, a main circuit module, and an output port module. The first controller has a first control input and a first control output, where the first control input is used to connect to an external power supply. The main circuit module has a voltage input and a voltage output, with the voltage input connected to the first control output. The main circuit module includes a transformer, where the primary winding of the transformer is connected to the voltage input, and the secondary winding of the transformer is connected to the voltage output. The output port module is connected to the voltage output, used to connect to an external load, and provides a charging voltage to the external load. The first controller is used to configure the external power source into multiple supply input voltages, all of which are of different magnitudes, and each supply input voltage forms multiple supply output voltages at the voltage output after being stepped down by the transformer. The output port module forms a charging voltage with one of the supply output voltages to supply power to the external load. The first control output can selectively output a supply input voltage based on the charging voltage, and/or the voltage output can selectively output another supply output voltage based on the charging voltage. The first controller can selectively output a supply input voltage based on the charging voltage output by the output port module, in order to reduce the difference between the input voltage of the first controller and the supply input voltage, thereby improving the energy conversion efficiency of the charging circuit. It is understandable that the voltage output of the main circuit module can also selectively output another supply output voltage based on the charging voltage, in order to reduce the difference between the supply output voltage and the charging voltage, which can also improve the energy conversion efficiency of the charging circuit. The first control output can selectively output a supply input voltage based on the charging voltage, and at the same time, the voltage output can selectively output another supply output voltage based on the charging voltage, which can also improve the energy conversion efficiency of the charging circuit.

### BRIEF DESCRIPTION OF THE DRAWINGS

In order to more clearly illustrate the technical solutions in this application, the drawings used in the description of the application will be briefly introduced below. The drawings described below are only some example of this application. For those skilled in the art, other drawings can also be obtained based on these drawings without creative effort.

FIG. 1 shows a schematic diagram of the framework of a charging circuit;

FIG. 2 shows a schematic diagram of the framework of another charging circuit;

FIG. 3 shows a schematic diagram of a voltage regulation circuit;

FIG. 4 shows a schematic diagram of the framework of an output port module;

FIG. 5 shows a schematic diagram of the framework of another charging circuit;

FIG. 6 shows a schematic diagram of a charging circuit; and

FIG. 7 shows a schematic diagram of the structure of a charger.

### Example Schematic Diagram Labels:

1, Charging Circuit;
11, First Controller;
111, First Control Input;
112, First Control Output;
12, Main Circuit Module;
12A, Voltage Input;
12A1, Live Line;
12A2, Neutral Line;
12B, Voltage Output;
121, Transformer;
122, Voltage regulation Circuit;
122A, Voltage regulation Input;
122B, Voltage regulation Output;
R1, Voltage Divider Resistor;
R2, Voltage regulation Resistor;
T1, voltage regulation switch component;
Q1, First Switching component;
Q2, Second Switching component;
C1, First Capacitor;
Q3, Third Switching component;
C2, Second Capacitor;
C3, Third Capacitor;
13, Output Port Module;
131, transformer circuit;
132, Power Supply Port;
14, Second Controller;
14A, Second Control Input;
14B, Second Control Output;
14C, Third Control Output;
15, Third Controller;
15A, Third Control Input;
15B, Fourth Control Output;
16, Fourth Controller;
16A, Fourth Control Input;
16B, Fifth Control Output;
16C, Sixth Control Output;
17, Fifth Controller;
2, Charger;
21, Housing;
22, Circuit Board.

### DETAILED DESCRIPTION

To make the objectives, technical solutions, and advantages of this application clearer and more comprehensible, the following detailed explanation of this application is provided in conjunction with the accompanying drawings. It should be understood that the specific examples described here are only used to explain this application and are not intended to limit the scope of this application.

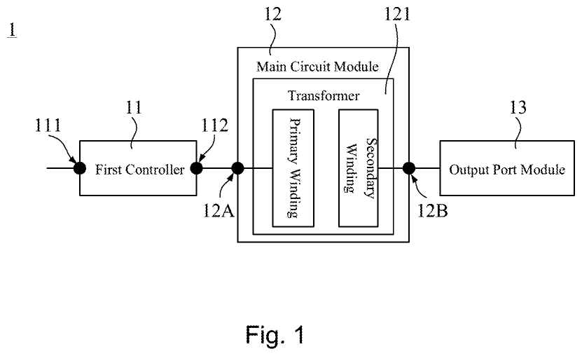

Referring to FIG. 1, the application provides a charging circuit 1, which comprises a first controller 11, a main circuit module 12, and an output port module 13. The first controller 11 has a first control input 111 and a first control output 112. The first control input 111 may be used to connect to an external power source. The main circuit module 12 has a voltage input 12A and a voltage output 12B. The voltage input 12A may be connected to the first control output 112. The main circuit module 12 comprises a transformer 121. The primary winding of the transformer 121 may be connected to the voltage input 12A, and the secondary winding of the transformer 121 may be connected to the voltage output 12B. The output port module 13 is connected to the voltage output 12B and may be used to connect to an external load and may provide a charging voltage to the external load.

The first controller 11 maybe configured to receive power at the voltage 12A from an external power source, configure the received power into one or more supply input voltages, and then provide one of the supply input voltages to another device (e.g., at the voltage input 12A). Each of the supply input voltages may be of different magnitudes, and each supply input voltage may form one or more supply output voltages at the voltage output 12B after being processed (e.g., stepped down) by the transformer 121. The output port module 13 maybe configured to use one of the supply output voltages to form a charging voltage to power the external load. The first control output 112 can selectively output a supply input voltage based on the charging voltage, and/or, the voltage output 12B can selectively output another supply output voltage based on the charging voltage. The supply input voltage and the supply output voltage can both be a specific voltage value or a voltage range, which can be selected according to actual usage requirements.

The first controller 11 can be set as a Power Factor Correction (PFC) device (e.g., module). Power factor (PF) refers to the relationship between effective power (e.g., working power) and total power consumption (e.g., apparent power), which is the ratio of effective power to total power consumption (e.g., apparent power) (PF=kW/kVA). Power factor may measure the degree to which electricity is used effectively. The higher the power factor value, the higher the electrical efficiency. The technology used to improve the power factor of electrical equipment is called power factor correction.

The first controller 11 maybe configured to adjust the supply output voltage at the first control output 112 according to (e.g., based on) the charging voltage of the output port module 13, in order to reduce the difference between the input voltage of the first controller 11 and the supply input voltage, thereby improving the energy conversion efficiency of the charging circuit 1.

The main circuit module 12 maybe used to reduce the supply input voltage provided by the first controller 11, so that the charging voltage can be output through the output port module 13 to power the external load. The output port module 13 may be connected to the external load and supply power to the external load with the charging voltage.

In an example, the first controller 11 can selectively output a supply input voltage according to the charging voltage output by the output port module 13, in order to reduce the difference between the input voltage of the first controller 11 and the supply input voltage, thereby improving the energy conversion efficiency of the charging circuit 1. It is understandable that the voltage output 12B of the main circuit module 12 can also selectively output another supply output voltage according to the charging voltage, in order to reduce the difference between the supply output voltage and the charging voltage, which can also improve the energy conversion efficiency of the charging circuit 1. The first control output 112 can selectively output a supply input voltage according to the charging voltage, and at the same time, the voltage output 12B can selectively output another supply output voltage according to the charging voltage, which can also improve the energy conversion efficiency of the charging circuit 1.

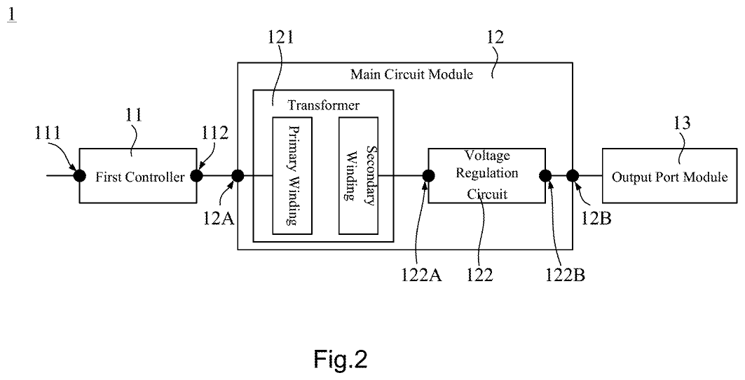

Referring to FIG. 2, in an example, the main circuit module 12 may comprise a voltage regulation circuit 122. The voltage regulation circuit 122 has a voltage regulation input 122A and a voltage regulation output 122B. The voltage regulation input 122A may be connected to the secondary winding of the transformer 121, and the voltage regulation output 122B may be connected to the voltage output 12B. Each power supply input voltage may be reduced by the transformer 121 and then processed by the voltage regulation circuit 122 to form multiple power supply output voltages. By using the voltage regulation circuit 122, the power supply input voltage after being reduced by the transformer 121 can be further processed to form multiple power supply output voltages. Thus, according to the charging voltage, the power supply output voltage can be adjusted to minimize the difference between the power supply output voltage and the charging voltage, thereby improving the energy conversion efficiency of the charging circuit 1.

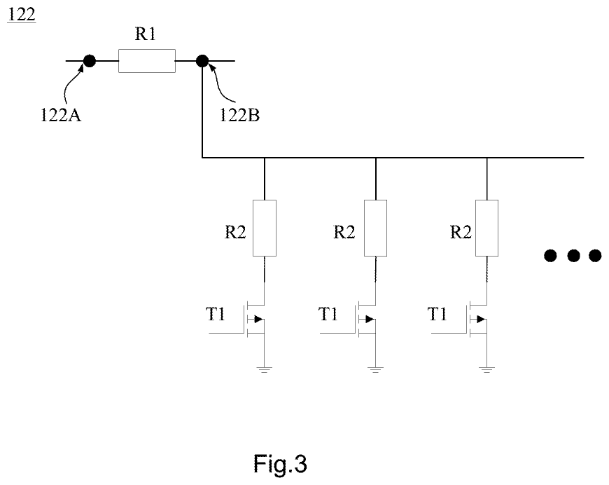

Referring to FIGS. 2 and 3, in an example, the voltage regulation circuit 122 may comprise a voltage divider resistor R1, multiple voltage regulation resistors

R2, and multiple voltage regulation switch components T1. The first end of the voltage divider resistor R1 may be connected to the voltage regulation input 122A, and the second end of the voltage divider resistor R1 may be connected to the voltage regulation output 122B. A first end of each voltage regulation resistor R2 may be connected to the second end of the voltage divider resistor R1, and the second end of each voltage regulation resistor R2 may be connected to at least one voltage regulation switch component T1. In addition, the second end of each voltage regulation resistor R2 may be connected to ground through the connected voltage regulation switch component T1. A voltage regulation resistor R2 may be connected to a respective voltage regulation switch component T1.

By controlling one or more voltage regulation switch components T1 to ground to change (e.g., adjust) the resistance value of the corresponding voltage regulation resistors R2, the total resistance value of the voltage regulation resistors R2 can be changed, thereby changing the supply output voltage at the voltage regulation output 122B. This reduces the difference between the supply output voltage and the charging voltage, in order to improve the energy conversion efficiency of the charging circuit 1.

The voltage regulation switch component T1 can be a regular switch component, for example, a single-pole switch. By operating the connection (e.g., conduction) and disconnection of the single-pole switch, the switching of the grounding state of the corresponding voltage regulation resistor R2 can be realized, thereby achieving the purpose of changing the total resistance value of the voltage regulation resistors R2.

In an example, the voltage regulation switch component T1 can also be a controlled switch component. The control terminal of the controlled switch component may be used to connect to the control signal, the second end of the voltage divider resistor R1 may be grounded through the controlled switch component, and the control signal can control the connection (e.g., conduction) and disconnection (e.g., cutoff) of the corresponding controlled switch component, to achieve the purpose of changing the total resistance value of the voltage regulation resistors R2. In an example, the controlled switch component can be a transistor or a field-effect transistor.

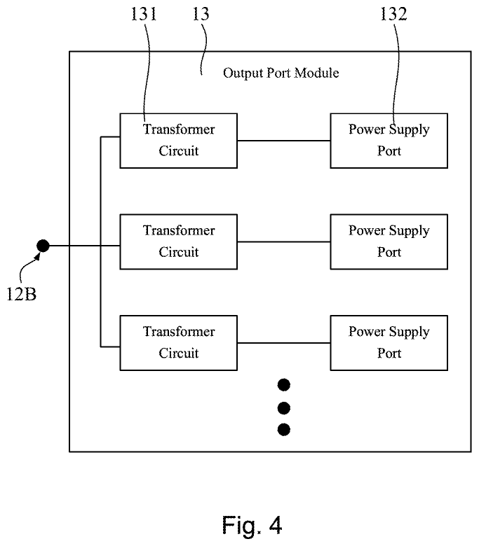

Referring to FIGS. 2 and 4, in an example, the output port module 13 may comprise multiple transformer circuits 131 and multiple power supply ports 132. Each power supply port 132 may be connected to the voltage output 12B through at least one transformer circuit 131. Each power supply port 132 may be used to connect with an external load. At least two power supply ports 132 may provide different charging voltages to their corresponding external loads. The first control output 112 may be configured to selectively output a power input voltage based on the highest charging voltage provided by all power supply ports 132, in order to reduce the difference between the input voltage of the first controller 11 and the power input voltage, thereby improving the energy conversion efficiency of the charging circuit 1.

It is understandable that, in an example, the voltage output 12B may be configured to selectively output another power output voltage based on the highest charging voltage provided by all power supply ports 132, in order to reduce the difference between the power output voltage and the charging voltage, which can also improve the energy conversion efficiency of the charging circuit 1.

It is understandable that, in another example, the first control output 112 may be configured to selectively output a power input voltage based on the highest charging voltage, and at the same time, the voltage output 12B may be configured to selectively output another power output voltage based on the highest charging voltage, which can similarly improve the energy conversion efficiency of the charging circuit 1.

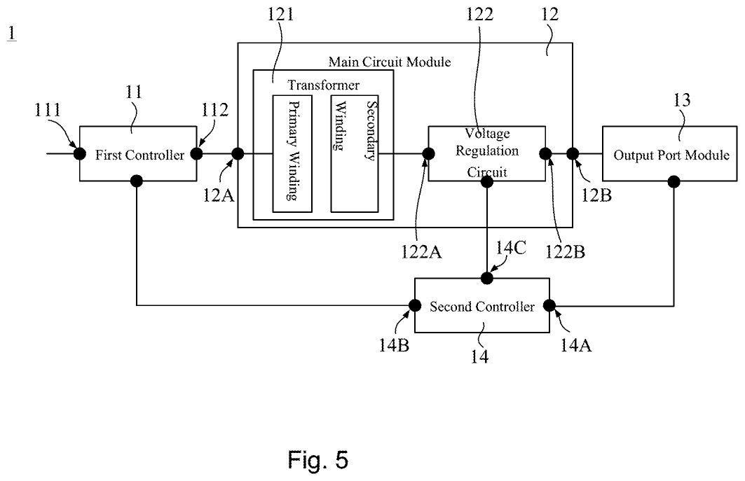

Referring to FIG. 5, in an example, the charging circuit 1 maycomprise a second controller 14. The second controller 14 comprises a second control input 14A, a second control output 14B, and a third control output 14C. The second control input 14A may be connected to the output port module 13, the second control output 14B may be connected to the controlled terminal of the first controller 11, and the third control output 14C may be connected to the voltage regulation controlled terminal of the voltage regulation circuit 122. The second controller 14 maybe configured to determine (e.g., detect) the current supply voltage output by the output port module 13 and control the first controller 11 based on the current supply voltage, so that the first control output 112 could selectively output a supply input voltage, to reduce the difference between the input voltage of the first controller 11 and the supply input voltage, thereby improving the energy conversion efficiency of the charging circuit 1.

It can be understood that, in an example, the second controller 14 maybe configured to determine the current supply voltage output by the output port module 13 and control the voltage regulation circuit 122 based on the current supply voltage, so that the voltage output 12B selectively could output another supply output voltage, to reduce the difference between the supply output voltage and the charging voltage, thereby improving the energy conversion efficiency of the charging circuit 1.

Referring to FIGS. 3 and 5. Specifically, the third control output 14C of the second controller 14 maybe connected to the controlled terminal of each voltage regulation switch component T1, so that the second controller 14 can control the switching on and off of each voltage-regulation switch component T1. This achieves the purpose of changing the total resistance value of the voltage regulation resistors R2, and thus can change the supply output voltage at the voltage regulation output 122B, in order to reduce the difference between the supply output voltage and the charging voltage, thereby improving the energy conversion efficiency of the charging circuit 1.

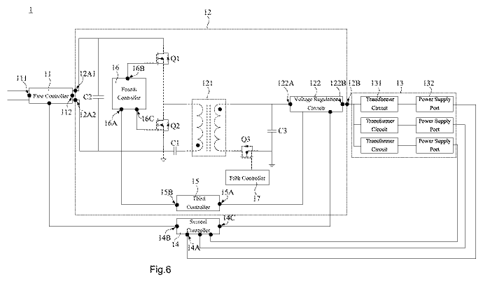

Referring to FIGS. 5 and 6. In an example, the voltage input 12A may comprise a live wire 12A1 and a neutral wire 12A2. The main circuit module 12 also may comprise a first switching component Q1, a second switching component Q2, a first capacitor C1, and a third switching component Q3. The input terminal of the first switching component Q1 may be connected to the live wire 12A1, and the output terminal of the first switching component Q1 may be connected to the first end of the primary winding. The input terminal of the second switching component Q2 may be connected to the output terminal of the first switching component Q1, and the output terminal of the second switching component Q2 may be connected to the neutral wire 12A2, and the output terminal of the second switching component Q2 may be grounded. The first plate of the first capacitor C1 may be connected to the second end of the primary winding, and the second plate of the first capacitor C1 may be connected to the output terminal of the second switching component Q2. The input terminal of the third switching component Q3 may be connected to the secondary winding, and the output terminal of the third switching component Q3 may be grounded. When the first switching component Q1 is conducting, the second switching component Q2 may be off (e.g., disconnected), and third switching component Q3 may be off, the supply input voltage charges the primary winding and the first capacitor C1. When the first switching component Q1 is off, the second switching component Q2 may be off, and the third switching component Q3 may be conducting, the electrical energy stored in the primary winding and the first capacitor C1 may be released to the secondary winding, causing the primary winding and the first capacitor C1 to charge the secondary winding, which in turn supplies power to the external load through the voltage output 12B and the output port module 13.

Specifically, the first switching component Q1, the second switching component Q2, and the third switching component Q3 can be either bipolar junction transistors (BJTs) or field-effect transistors (FETs). These transistors or FETs may only need to receive control signals from a controller to switch between the off and on states, which can improve the ease of control for the first switching component Q1, the second switching component Q2, and the third switching component Q3. This also effectively simplifies the circuit structure of the charging circuit 1, serving the purpose of cost savings. In an example, the first switching component Q1, the second switching component Q2, and the third switching component Q3 can all be gallium nitride (GaN)

FETs. GaN FETs have relatively low internal resistance and junction capacitance, which can further reduce the losses caused by internal resistance and junction capacitance, thereby improving the energy conversion efficiency of the charging circuit 1. In another example, the first switching component Q1, the second switching component Q2, and the third switching component Q3 can all be silicon carbide (SiC)

FETs. In another example, one or more of the first switching component Q1, the second switching component Q2, and the third switching component Q3 can be SiC FETs or GaN FETs.

Referring to FIGS. 5 and 6, in an example, the charging circuit 1 mayalso comprise a third controller 15. The third controller 15 maycomprise a third control input 15A and a fourth control output 15B. The third control input 15A may be connected to the voltage regulation output 122B, and the fourth control output 15B may be connected to the voltage-controlled terminal of the main circuit module 12. The third controller 15 maybe configured to determine (e.g., detect) the supply output voltage and, based on the supply output voltage, adjust (e.g., increase) the duty cycle of the first switching component Q1, the second switching component Q2, and the third switching component Q3, so as to selectively output another supply output voltage at the voltage output 12B, thereby improving the energy conversion efficiency of the charging circuit 1. At the same time, due to the increase in the duty cycle of the first switching component Q1, the second switching component Q2, and the third switching component Q3, the current stress borne by the first switching component Q1, the second switching component Q2, and the third switching component Q3 may be reduced, resulting in less heat generation by these components. This reduction in heat generation may decrease the thermal losses of the first switching component Q1, the second switching component Q2, and the third switching component Q3, thereby extending their service life and, consequently, the service life of the charging circuit 1. The third controller 15 mayinclude an optocoupler reflection circuit and a regulator. In an example, the third controller 15 can also be other circuit structures capable of adjusting the duty cycle of pulse signals to meet the objective of improving the energy conversion efficiency of the charging circuit 1.

Referring to FIG. 6, in an example, the main circuit module 12 mayalso comprise a fourth controller 16. The fourth controller 16 maycomprise a fourth control input 16A, a fifth control output 16B, and a sixth control output 16C. The fourth control input 16A may be connected to the fourth control output 15B for receiving control signals sent by the third controller 15. The fifth control output 16B may be connected to the controlled terminal of the first switching component Q1, and the sixth control output 16C may be connected to the controlled terminal of the second switching component Q2. The fourth controller 16 maybe configured to control the on and off states of the first switching component Q1 and the second switching component Q2 based on the control signals sent from the third controller 15 to the fourth controller 16, thereby adjusting the duty cycle of the first switching component Q1 and the second switching component Q2 to improve the energy conversion efficiency of the charging circuit 1.

Referring to FIG. 6, in an example, the main circuit module 12 mayalso comprise a fifth controller 17. The fifth controller 17 maybe connected to the controlled terminal of the third switching component Q3 and may be configured to control the on and off states of the third switching component Q3, thereby adjusting the duty cycle of the third switching component Q3 to improve the energy conversion efficiency of the charging circuit 1.

Referring to FIG. 6, in an example, the main circuit module 12 mayalso comprise a second capacitor C2. A first plate of the second capacitor C2 may be connected to the live wire 12A1, and a second plate of the second capacitor C2 may be connected to the neutral wire 12A2. Specifically, the AC power from an external power source may be converted into DC power after passing through a rectifier bridge. The second capacitor C2 can be used to filter the DC power to remove noise from the DC current.

Referring to FIG. 6, in an example, the main circuit module 12 may also comprise a third capacitor C3. A first plate of the third capacitor C3 may be connected to the voltage output 12B, and the second plate of the third capacitor C3 may be connected to the output end of the third switching component Q3. By using the third capacitor C3, the output voltage formed at the secondary winding can be filtered. In addition, the third capacitor C3 can store the residual secondary voltage after the secondary winding has charged the external load.

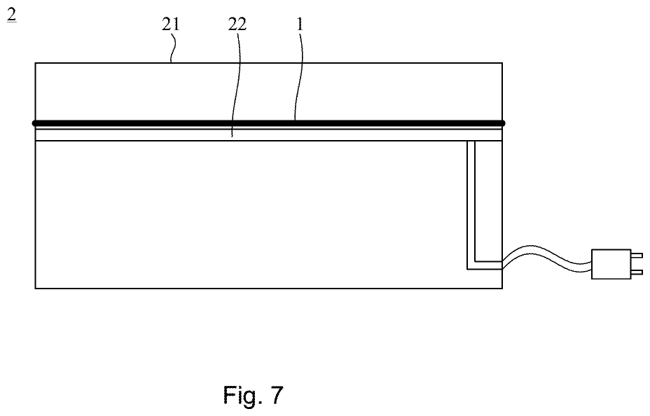

Referring to FIGS. 6 and 7, a charger 2 (e.g., an electric charger, a charger for an electronic device such as a mobile phone) comprises a housing 21, a circuit board 22, and a charging circuit 1. The circuit board 22 maybe set within the housing 21, and the charging circuit 1 maybe mounted on the circuit board 22. The circuit board 22 can be a flexible printed circuit (FPC), a printed circuit board (PCB), or a flexible printed circuit board (FPCB). The charger 2 formed by the charging circuit 1 mayhave a higher energy conversion efficiency.

Specifically, by increasing the duty cycle of the first switching component (e.g., first switch) Q1, the second switching component (e.g., second switch) Q2, and the third switching component (e.g., third switch) Q3, it is possible to reduce the current stress on the first switching component Q1, the second switching component Q2, and the third switching component Q3. This reduction in current stress decreases the heat generated by the first switching component Q1, the second switching component Q2, and the third switching component Q3, thereby reducing their thermal losses. This allows for a reduction in the size of the internal electronic components of the charging circuit 1, which increases the layout density of the internal electronic components within the charging circuit 1, and ultimately reduces the size of the charger 2.

In the drawings of this embodiment, the same or similar reference numerals correspond to the same or similar parts; it should be understood in the description of this application that if terms such as “upper,” “lower,” “left,” “right,” and other directional or positional relationships are based on the orientation or positional relationships shown in the drawings, they are merely for the convenience of describing this application and simplifying the description, and do not indicate or imply that the devices or components referred to must have a specific orientation, be constructed and operated in a specific orientation. Therefore, the terms describing positional relationships in the drawings are only for illustrative purposes and should not be construed as limiting this patent. Those skilled in the art can understand the specific meanings of the above terms based on the specific circumstances.

The above are only preferred example of this application and are not intended to limit this application. Any modifications, equivalent replacements, and improvements made within the spirit and principles of this application should be included within the protection scope of this application.

What is claimed is:

1. A charging circuit, comprising:
a first controller comprising a first control input and a first control output;
a transformer connected to the first control output; and
an output port circuit connected to the transformer, wherein:
the first controller is configured to determine a plurality of supply input voltages based on an external power source,
the transformer is configured to process each supply input voltage of the plurality of supply input voltages to form a plurality of supply output voltages,
the output port circuit is configured to output a charging voltage from one of the plurality of supply output voltages to power an external load, and
the first controller is configured to output one of the plurality of supply input voltages based on the charging voltage.

2. The charging circuit according to claim 1, further comprising:
a voltage regulation circuit comprising a voltage regulation input and a voltage regulation output, wherein the voltage regulation input is connected to the transformer, and the voltage regulation output is connected to the output port circuit, and wherein each of the plurality of supply input voltages is processed by the voltage regulation circuit to output the plurality of supply output voltages.

3. The charging circuit according to claim 2, wherein the voltage regulation circuit comprises a voltage divider resistor, a plurality of voltage regulation resistors, and a plurality of voltage regulation switch components.

4. The charging circuit according to claim 3, wherein:
a first end of the voltage divider resistor is connected to the voltage regulation input, and a second end of the voltage divider resistor is connected to the voltage regulation output,
a first end of each of the plurality of voltage regulation resistors is connected to the second end of the voltage divider resistor, and a second end of each of the plurality of voltage regulation resistors is connected to at least one voltage regulation switch, and
the second end of each of the plurality of the voltage regulation resistors is connected to a ground via the voltage regulation switch.

5. The charging circuit according to claim 2, further comprising:
a second controller comprising a second control input, a second control output, and a third control output, wherein:
the second control input is connected to the output port circuit, the second control output is connected to the first controller, and the third control output is connected to the voltage regulation circuit.

6. The charging circuit according to claim 5,wherein:
the second controller is configured to determine a current supply voltage output by the output port circuit, and
control, based on the current supply voltage, the first control output to output the one of the plurality of supply input voltages.

7. The charging circuit according to claim 5,wherein:
the second controller is configured to determine a current supply voltage output by the output port circuit, and
control, based on the current supply voltage, the voltage regulation circuit to output another supply output voltage.

8. The charging circuit according to claim 1, wherein:
the output port circuit comprises a plurality of transformer circuits and a plurality of supply ports,
each of at least two of the plurality of supply ports provides a different charging voltage to a respective external load.

9. The charging circuit according to claim 1, wherein the transformer comprises a primary winding, a secondary winding, a live wire, and a neutral wire, and the charging circuit further comprises:
a first switch connected between the live wire and the primary winding;
a second switch connected to the first switch and the neutral wire, wherein an output of the second switch is grounded;
a first capacitor connected between the primary winding and the second switch; and
a third switch connected to the secondary winding, wherein an output end of the third switch is grounded.

10. The charging circuit according to claim 9, wherein the charging circuit further comprises:
a third controller comprising a third control input and a fourth control output, wherein the third controller is configured to determine the supply output voltage and adjust a duty cycle of the first switch, the second switch, and the third switch based on the supply output voltage.

11. The charging circuit according to claim 10, wherein the charging circuit further comprises:
a fourth controller comprising a fourth control input, a fifth control output, and a sixth control output, wherein:
the fourth control input is connected to the fourth control output, the fifth control output is connected to the first switch, and the sixth control output is connected to the second switch, and
the fourth controller is configured to control switching on and off of the first switch and second switch.

12. An electric charger comprising:
a housing;
a circuit board in the housing, wherein the circuit board comprises
a charging circuit, comprising:
a first controller comprising a first control input and a first control output;
a transformer connected to the first control output; and
an output port circuit connected to the transformer, wherein:
the first controller is configured to determine a plurality of supply input voltages based on an external power source,
the transformer is configured to process each supply input voltage of the plurality of supply input voltages to form a plurality of supply output voltages,
the output port circuit is configured to output a charging voltage from one of the plurality of supply output voltages to power an external load, and
the first controller is configured to output one of the plurality of supply input voltages based on the charging voltage.

13. The electric charger of claim 12, wherein the charging circuit further comprises:
a voltage regulation circuit comprising a voltage regulation input and a voltage regulation output, wherein the voltage regulation input is connected to the transformer, and the voltage regulation output is connected to the output port circuit, and wherein each of the plurality of supply input voltages is processed by the voltage regulation circuit to output the plurality of supply output voltages.

14. The electric charger of claim 13, wherein the voltage regulation circuit comprises a voltage divider resistor, a plurality of voltage regulation resistors, and a plurality of voltage regulation switch components.

15. The electric charger of claim 14, wherein:
a first end of the voltage divider resistor is connected to the voltage regulation input, and a second end of the voltage divider resistor is connected to the voltage regulation output,
a first end of each of the plurality of voltage regulation resistors is connected to the second end of the voltage divider resistor, and a second end of each of the plurality of voltage regulation resistors is connected to at least one voltage regulation switch, and
the second end of each of the plurality of the voltage regulation resistors is connected to a ground via the voltage regulation switch.

16. The electric charger of claim 13, wherein the charging circuit further comprises:
a second controller comprising a second control input, a second control output, and a third control output, wherein:
the second control input is connected to the output port circuit, the second control output is connected to the first controller, and the third control output is connected to the voltage regulation circuit.

17. The electric charger of claim 16, wherein:
the second controller is configured to determine a current supply voltage output by the output port circuit, and
control, based on the current supply voltage, the first control output to output the one of the plurality of supply input voltages.

18. The electric charger of claim 16, wherein:
the second controller is configured to determine a current supply voltage output by the output port circuit, and
control, based on the current supply voltage, the voltage regulation circuit to output another supply output voltage.

19. The electric charger of claim 12, wherein:
the output port circuit comprises a plurality of transformer circuits and a plurality of supply ports,
at least two of the plurality of supply ports provide different charging voltages to two corresponding external loads.

20. The electric charger of claim 12, wherein the transformer comprises a primary winding, a secondary winding, a live wire, and a neutral wire, and the charging circuit further comprises:
a first switch connected between the live wire and the primary winding;
a second switch connected to the first switch and the neutral wire, wherein an output of the second switch is grounded;
a first capacitor connected between the primary winding and the second switch; and
a third switch connected to the secondary winding, wherein an output end of the third switch is grounded.
